(19) United States
(12) Patent Application Publication
(10) Pub. No.: US 2026/0240093 A1
(43) Pub. Date: Aug. 20, 2026

(54) Sprinkler Head and Distributed Irrigation System and Method

(71) Applicant: Vincent Loccisano, Wellesley, MA (US)

(72) Inventor: Vincent Loccisano, Wellesley, MA (US)

(21) Appl. No.: 19/641,337

(22) Filed: Apr. 7, 2026

(51) Int. Cl. A01G 25/16; B05B 3/02; B05B 3/16

(52) U.S. Cl. CPC A01G 25/165; B05B 3/0202; B05B 3/16

(57) ABSTRACT

A water-powered sprinkler head, system and method capable of digitally addressable sector-based irrigation delivers water to specific angular segments at controlled flow rates and volumes. The device includes an inline micro-turbine generator, energy storage, wireless mesh communication, and programmable flow control, enabling highly specific and adaptive watering applications.

### FIELD OF THE INVENTION

The present invention relates to irrigation systems and more specifically to underground sprinkler heads incorporating hydraulic energy harvesting, distributed, wireless mesh networking, and precision, digitally addressable water distribution control.

### BACKGROUND

Conventional irrigation systems operate at the zone level and rely on passive sprinkler heads. Existing devices offer fixed flows and limited mechanical arc-adjustment. They cannot dynamically tailor watering profiles to specific landscape geometries, soil conditions and soil-type variations, plant types, or real-time sensor data. An intelligent sprinkler head would provide per-head, programmable, sector-based, flow-controlled, and volume-controlled irrigation.

An angular bin (aka “angular segment” or “arc sector”) refers to a specific segment of the 360-degree circle that an irrigation head (sprinkler) covers. A sprinkler head's rotation might not reach all sections equally. Segmenting each area into “bins” enables the adjustment of each section (bin) of an area to be irrigated.

A mesh network is a decentralized communication-network topology where each device connects directly to as many other devices as possible. Unlike a traditional network, where all devices talk to a single central hub (e.g., a router), devices or nodes in a mesh network cooperate to efficiently route data to its destination.

Irrigation mapping involves creating a digital or physical blueprint of a landscape's watering needs. It enables high-precision irrigation that can address topographical, soil, and other physical differences of an area. An irrigation map might define zone boundaries, pipe routing, and sprinkler-head placement.

In low-power mesh technologies, a “supercap (supercapacitor) wakeup” refers to a power-management architecture that allows an Internet-of-Things device to manage and augment the performance of a traditional battery. Directed by a microcontroller, a supercapacitor accumulates sipped power during irrigation down-times, and releases power in a “wakeup” at timed intervals in controlled amounts.

A “micro-hydro” is a small-scale power plant that converts the energy of flowing water (a stream, creek, or a large irrigation pipe) into a few watts of electricity.

A “funny pipe” is a thick-walled, highly flexible polyethylene tubing used to connect a rigid underground PVC pipe to a sprinkler head.

The Hall Effect is a method for converting the physical movement of water into digital data (in RPM) that a controller can understand. As water flows, an impeller (turbine) spins. The impeller's shaft and/or blades are fitted with tiny magnets. Each time a magnet passes a sensor, the Hall effect triggers a pulse. If the water flows faster, the wheel spins faster, and the pulses happen more frequently.

Telemetry is the process of recording and transmitting the readings of an instrument.

Bluetooth Low-Energy (BLE) is a wireless communication technology designed to connect devices over short distances while using small amounts of power.

Capacitance Time Domain Reflectometry (TDR) is a high-precision measurement technique used to determine the moisture content of materials such as soil.

### SUMMARY OF THE INVENTION

In a network of irrigation sprinklers, a self-powered sprinkler head harvests power from irrigation water via a micro-turbine generator, requiring no batteries in normal operation. Each sprinkler head has sensors that detect soil moisture and collect data about the current water capacity of the soil adjacent to it. The data determines whether the ground needs water. Sensor data may be used to generate a profile about how soil composition (sandy, clay, rocky) affects moisture retention. In an embodiment, a temperature sensor communicates ambient and soil temperatures to the system. In another embodiment, fertilizer content is gauged by use of Capacitance Time Domain Reflectometry (CTDR).

Each sprinkler head is a mesh radio module with an antenna under the cap with a RF transparent window, enabling each to communicate wirelessly with others in the network. Each head is individually addressable within a distributed irrigation network. The sprinkler head selectively delivers water to a precisely defined, angular segment of a circular spray pattern, at a specifically controlled flow rate, for a precisely controlled, delivered volume.

The device allows fine-grained irrigation mapping across a landscape, storing multiple irrigation profiles that can be selected remotely.

The sprinkler head stores a sector-based irrigation map in memory, in which each angular bin contains a programmed water-application value. During operation, the head references this map and adjusts flow output as the rotating nozzle traverses each angular bin. In certain embodiments, the device may operate in a pulsed-delivery mode in which short-duration flow bursts are applied to specific angular bins, to minimize runoff and improve soil-absorption characteristics.

The device forms a self-healing mesh network between heads, in which commands “hop” across a watering area. The device achieves digitally addressable watering by controlling aspects such as throw distance (radius); arc segments (start angle and end angle); and application amounts (flow rate×time and per-angle “dose-mapping”). This is described in detail below.

The system can be integrated with existing underground systems by use of standard ½″ NPT (or BSP variants) inlet threads, compatible with common swing joints or “funny pipe” tubing.

Like conventional heads, the sprinkler heads may be of the above- or below-ground pop-up-canister type with a riser that extends when pressurized. They are serviceable in the same way as conventional systems, with a top cap/ring removable from above ground, and electronics sealed in a lower “dry bay.”

It may be a single head that gets replaced with this invention or multiple heads may be replaced in a zone. This allows more specific watering of areas that have things like multiple watering needs (two types of grass/flowers) or the desire to not water things like driveways or walkways.

The system and method applies to residential and industrial applications. It may be used in a new sprinkler system rollout, or retrofitted to an existing in-ground sprinkler system.

### BRIEF DESCRIPTION OF THE FIGURES

FIG. 1 shows an example embodiment of a sprinkler head.

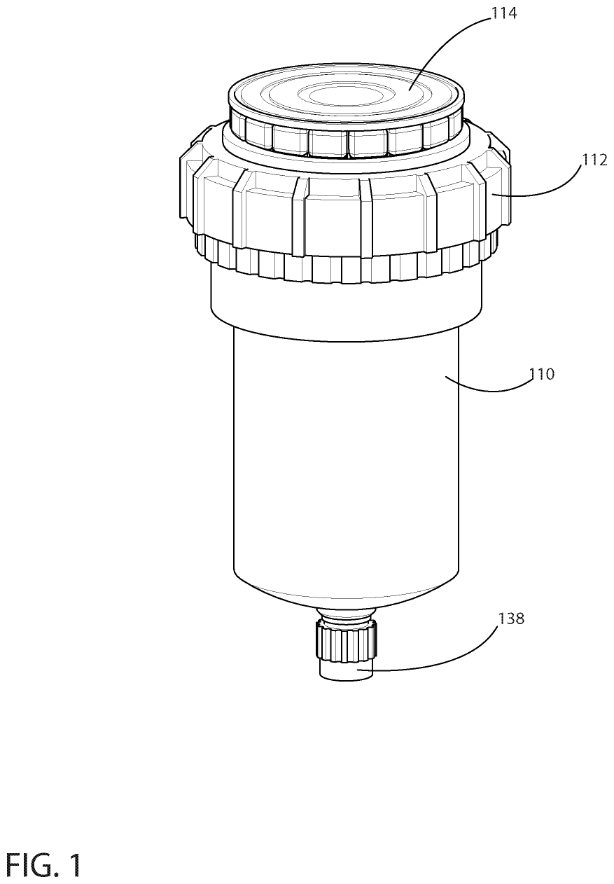

FIG. 2 is a partial cutaway view of the sprinkler head.

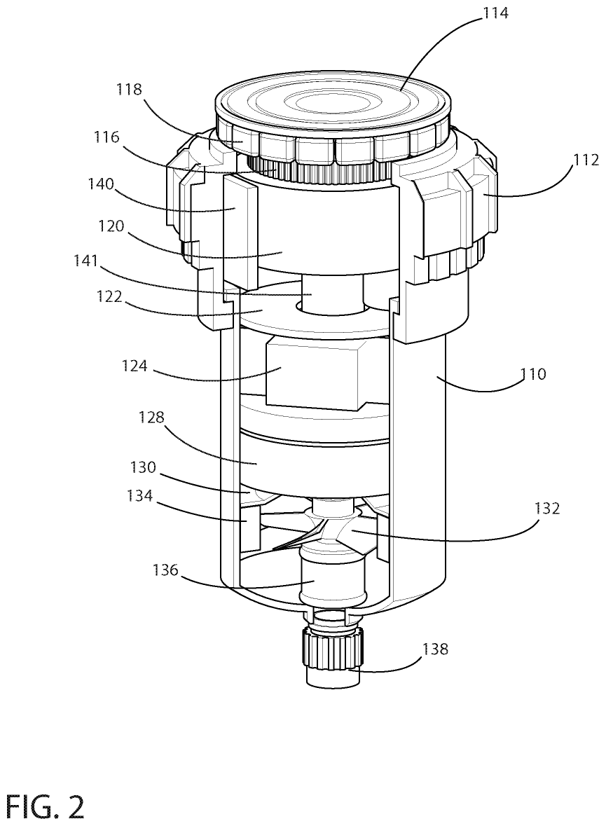

FIG. 3 is an exploded view of the sprinkler head.

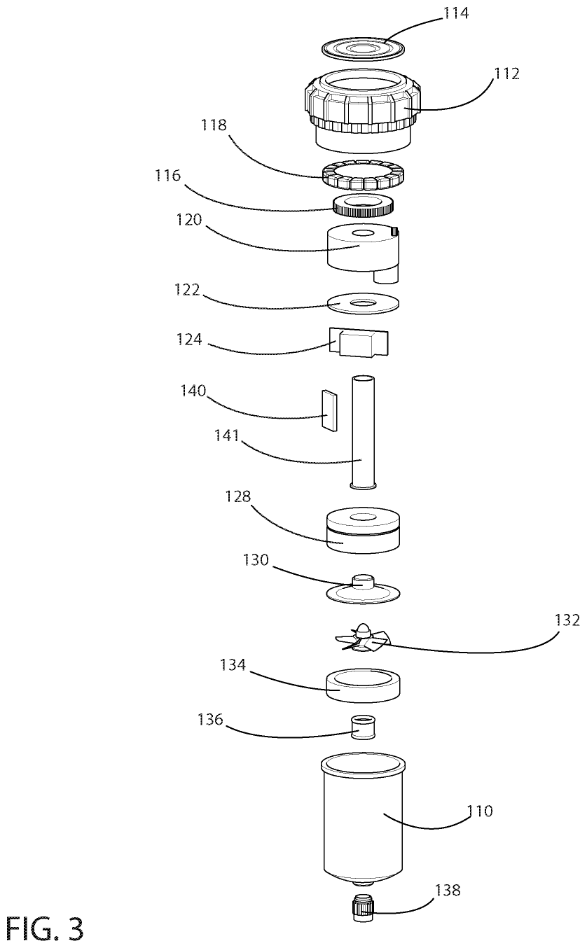

FIG. 4 is a flowchart showing a method used by the sprinkler-head system.

### DESCRIPTION OF THE DRAWINGS

The sprinkler head is a pop-up canister type, with a riser that extends under pressure. A removable top cap 112 provides above-ground access to a sealed “dry bay” that resides between a conduit 141 and a housing 110 that houses the electronics. The internal flow path flows from the inlet 138 through the debris filter 136 through the micro-turbine generator rotor 132 and the proportional flow-control valve 130, through the conduit 141, through the rotating nozzle ring 118 and finally through the outlet sprayer 114.

The device is primarily water-powered, with an internal axial or crossflow micro-turbine 132 that is optimized for irrigation flow rates. A generator assembly 134 includes a three-phase PM alternator and rectifier. Power is managed by a PMIC (Power Management Integrated Circuit) is part of a circuit board 124. The PMIC regulates energy distribution to a primary energy-storage device, a supercapacitor 128, and a LifePO4 backup cell for use during brownouts or periodic “wakeup” cycles, when the zone is unpressurized. This inline configuration ensures power generation whenever the zone is active, with minimal pressure loss.

Based on a programmed sector map stored in local memory, the circuit board 124 supports a microcontroller that adjusts, in real time, a proportional flow-control valve 130 and rotating nozzle assembly 118. A mesh radio module is included in the circuit board 112 and is configured to transmit and receive irrigation telemetry, as well as coordinate instructions with similar sprinkler heads.

Through flow-metering and closed-loop dosing, the sprinkler head independently controls where, how far, and how much water to send. It uses two implementation paths: The first uses a stepper-controlled rotor with programmable arc stops. In this implementation, a rotor spins but is constrained to an electronically adjustable start/stop arc. The arc range covers any segment from, for example, from 10° to 360°. Angle resolution is from 1 to 2° with stepper and encoder.

In a second implementation, an addressable nozzle ring provides “aim anywhere” micro-zoning. Here, a ring of micro-nozzles (e.g., 24-72 ports) each has a micro-valve or a rotating shutter. Only the ports that correspond to the desired angles open. To provide precise, “aim-anywhere” micro-zoning, an embodiment of the head uses three primary control variables: arc positioning, radius control, and micro-zoning. In some embodiments, a control variable is defined as volume per sector (in gallons) rather than just duration.

In an embodiment, a digitally controlled nozzle assembly enables arc positioning by defining programmable start/stop angles (θ1,θ2) in increments as small as 1°. In an embodiment, The nozzle assembly is driven by stepper motor 120, which is controlled by a stepper-motor circuit board 122 that communicates with circuit board 124.

In an embodiment, the sprinkler head achieves radius control by adjusting the angle of the rotating nozzle assembly 118 by rotating the nozzle assembly 118 with the servo motor 120 moving a drive gear 116. Throw distance is adjusted by a combination of a proportional upstream flow-valve (or fast PWM valve); selectable nozzle apertures in a multi-orifice turret (which are part of the nozzle assembly 118), and a servo-controlled deflector vane. Typical throw ranges are landscape-relevant, covering short (5-15 ft), medium (15-30 ft), and long (30-50+ ft) radii.

In an embodiment, a circumferential array (24-72 ports) of individually addressable micro-nozzles in the nozzle assembly 118 allows the head to deliver water only within specific angular segments. A ring of micro-nozzles in the nozzle assembly 118 (with, for example, 24-72 ports) each has a micro-valve or a rotating shutter. Only the ports that correspond to the desired angles open. This enables per-sector “dose mapping” (more water at some angles, less at others). Sector-specific irrigation compensates for topographical variations such as slope.

The sprinkler head performs closed-loop dosing and analytics, executing volume-based delivery rather than simple timed cycles. It uses feedback transmitted by sensing flow via the Hall Effect, or may infer flow from the generator RPM plus valve state (with calibration). The Hall Effect measures RPMs from the turbine, as well as information about the valve state and from pressure sensors, to compute delivered fluid volume as:

$$V = \int Q ( θ , t ) dt$$

Here, the total volume (Vsector) represents total gallons or liters watered in a specific zone. This total volume is the sum of the flow rate (Q) over the entire time the system was running.

The system logs and reports telemetry including delivered volume, sector-specific distribution maps, supply pressure estimates, and health metrics (e.g., leaks or clogs in the sprinklers). A clogged or damaged head is made evident by report of, for example, low GPM based on volume flow and pressure. This activates a shutoff of a destroyed head and notifies a user to investigate. This built-in logic prevents massive under- or over-watering well in advance.

Each head acts as a node in a distributed, self-healing mesh network. In a preferred embodiment, the heads communicate via 802.15.4 Thread/Zigbee or Sub-GHz. A Thread/Zigbee protocol works well in dense landscapes, as well as in low-power settings and multiple-node networks. Sub-GHz mesh (e.g., 868/915 MHz) provides a better range through foliage or terrain, with fewer communication “hops.” In smaller applications, the mesh network may communicate via Bluetooth or Bluetooth Low-Energy (BLE).

An antenna 140 is housed under the cap behind an RF-transparent window. The network supports:
Command Flooding: Simultaneous broadcasting of instructions to all devices.
Routed Unicasting: Multi-hop messaging to specific Head IDs (e.g., HEAD_ID|START_ANGLE|STOP_ANGLE|FLOW_PROFILE|TARGET_VOLUME).
Dynamic Updates: Real-time adjustments to sector maps based on weather, soil moisture, or supervisory software.
Time Sync: In one embodiment, individual sprinkler heads may talk to a gateway that ultimately connects to the web or wifi, enabling them to be programmed as needed via the internet, intranet or app. This gateway additionally acts as a sprinkler controller for each zone of sprinkler heads that considers weather data like recent rainfall or drastic temperature changes. The gateway is capable of delivering power to existing sprinkler zone valves. (typically 12-24 volts AC, via existing cables). The sprinkler heads are programmed via an interface that acts as a sprinkler controller (a timer) or one that controls head direction and water quantity.

Coordinated activation and telemetry is backhauled to a central gateway.

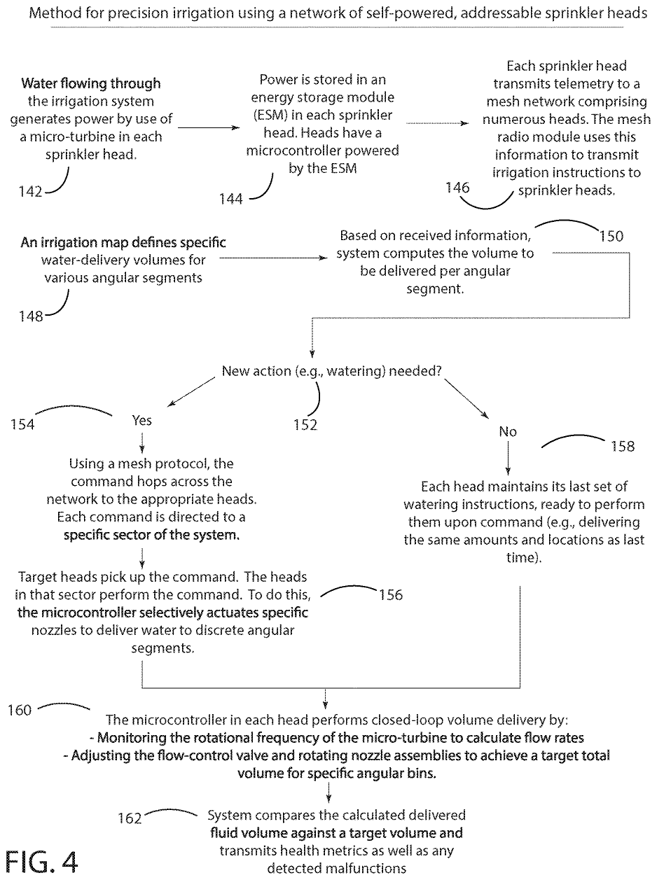

The flowchart of FIG. 4 shows a method for precision irrigation using a network of self-powered, addressable sprinkler heads. Water flowing through the irrigation system generates power 142 by use of a micro-turbine in each sprinkler head. Power is stored in an energy storage module (ESM) in each sprinkler head. Heads have a microcontroller 144 powered by the ESM. Each sprinkler head transmits telemetry to a mesh network comprising numerous heads. The mesh radio module uses this information to transmit irrigation instructions 146 to sprinkler heads. An irrigation map defines specific water-delivery volumes for various angular segments 148. Based on received information, the system 150 computes the volume to be delivered per angular segment. If a new action (e.g., watering) is called for 152, the command is communicated, via a mesh protocol, across the network to the appropriate heads. Each command is directed to a specific sector of the system 154. Target heads pick up and perform the command in that sector. To do this, the microcontroller selectively actuates specific nozzles to deliver water to discrete angular segments 156.

If no command is to be executed 158, each head maintains its last set of watering instructions, ready to perform them upon command (e.g., delivering the same amounts and locations as last time).

The microcontroller in each head performs closed-loop volume delivery 160 by:
Monitoring the rotational frequency of the micro-turbine to calculate flow rates
Adjusting the flow-control valve and rotating nozzle assemblies to achieve a target total volume for specific angular bins.

The system compares calculated delivered fluid volume against a target volume, and transmits health metrics as well as any detected malfunctions 162.

1. An automated irrigation sprinkler head comprising:
a housing defining a dry bay; and
a conduit defining a fluid flow path, passing through the dry bay, extending from an inlet to an outlet; and
a micro-turbine generator positioned in-line with the conduit, configured to generate electrical power from fluid flowing through the fluid flow path; and
a power management system comprising a power management integrated circuit, a primary energy storage device and a secondary backup cell; and
a mesh radio module configured to transmit and receive irrigation telemetry and coordinate instructions with a plurality of similar sprinkler heads; and
a flow-control valve and a rotating nozzle ring; and
a microcontroller configured to adjust the flow-control valve and rotating nozzle ring, in real time, based on a programmed sector map that is stored in local memory.

2. The sprinkler head of claim 1 wherein:
the micro-turbine generator comprises a three-phase permanent magnet alternator and a rectifier; and wherein
the primary energy storage device is a supercapacitor configured to provide high-current bursts for radio transmission and motor actuation.

3. The sprinkler head of claim 1 further comprising:
a circumferential array of individually addressable micro-nozzles; wherein
the microcontroller selectively actuates at least one of the individually addressable micro-nozzles to deliver water to discrete angular segments of a 360° arc.

4. The sprinkler head of claim 1 wherein:
the flow-control valve is a proportional flow-control valve; wherein
the microcontroller performs closed-loop volume delivery by monitoring a rotational frequency of the micro-turbine generator to calculate real-time flow rate and adjusting the proportional flow-control valve to achieve a target total volume for a specific angular bin.

5. The sprinkler head of claim 1 wherein:
the mesh radio module, power management system, and microcontroller are housed within the dry bay.

6. The sprinkler head of claim 1 wherein:
a radius of water throw is dynamically adjusted during a single rotation by the microcontroller through the simultaneous manipulation of the flow-control valve and a servo-controlled deflector vane.

7. A self-powered, distributed irrigation sprinkler head comprising:
a housing having an inlet for receiving pressurized water and a nozzle assembly for discharging said water; and
a micro-turbine generator disposed within a flow path between the inlet and the nozzle assembly, configured to harvest electrical energy from a flow of water; and
an energy storage system comprising at least one supercapacitor electrically coupled to the micro-turbine generator; and
a flow-control valve configured to adjust a flow rate of water to the nozzle assembly; and
a wireless mesh radio module configured to communicate with a plurality of similar sprinkler heads in a decentralized network; and
a controller in communication with the flow-control valve and the wireless mesh radio module, the controller having a memory storing a sector-based irrigation map comprising a plurality of angular bins, each bin having a programmed water-application value; wherein
the controller is configured to adjust the flow-control valve in real-time as the nozzle assembly traverses each angular bin based on the sector-based irrigation map.

8. The sprinkler head of claim 7 wherein:
the energy storage system further comprises a battery cell configured to power the wireless mesh radio module during periodic wakeup cycles when the inlet is unpressurized.

9. The sprinkler head of claim 7 further comprising:
a Hall Effect sensor configured to measure rotation of the micro-turbine generator to determine a real-time flow rate and a delivered fluid volume.

10. The sprinkler head of claim 7 wherein:
the nozzle assembly comprises a stepper-motor-controlled rotor configured to define an electronically adjustable start angle and stop angle.

11. The sprinkler head of claim 7 wherein:
the nozzle assembly comprises a circumferential array of individually addressable micro-nozzles, each micro-nozzle having a dedicated valve or shutter to enable per-sector dose mapping.

12. The sprinkler head of claim 7 further comprising:
at least one sensor selected from the group consisting of: a soil moisture sensor, a temperature sensor, and a Capacitance Time Domain Reflectometry (CTDR) sensor for measuring fertilizer content.

13. The sprinkler head of claim 7 wherein:
the housing includes a top cap comprising an RF-transparent window, and wherein an antenna coupled to the wireless mesh radio module is disposed beneath said RF-transparent window.

14. The sprinkler head of claim 7 wherein:
the controller is configured to detect a localized hardware fault by comparing a measured flow rate against an expected flow rate for a given valve state and supply pressure; and
identifying a clog if the measured flow rate falls below a predetermined threshold; and
identifying a structural break if the measured flow rate exceeds the predetermined threshold.

15. The sprinkler head of claim 14 wherein:
the controller is further configured to execute a local emergency shut-off of the flow-control valve upon identifying the structural break and transmit a fault notification via the wireless mesh radio module.

16. A method for precision irrigation using a network of self-powered, addressable sprinkler heads, the method comprising:
harvesting hydraulic energy from water flowing through an internal turbine of a sprinkler head to charge an onboard energy storage device; and
storing a digital irrigation map in a local memory of the sprinkler head, the map defining specific water-delivery volumes for a plurality of angular segments; and
receiving telemetry or command data from a neighboring sprinkler head via a wireless mesh network; and
rotating a nozzle assembly through a circular spray pattern; and
dynamically adjusting a flow-control valve during rotation to deliver a specific volume of water to each angular segment as defined by the digital irrigation map.

17. The method of claim 16 further comprising:
operating the flow-control valve in a pulsed-delivery mode to provide short-duration flow bursts to selected angular segments to improve soil absorption.

18. The method of claim 16 further comprising:
calculating a delivered fluid volume (V) by integrating a flow rate (Q) over time (t) according to a formula:
$$V = \int Q ( ∅ , t ) dt$$
where Ø represents a respective angular segment being irrigated.

19. The method of claim 18 further comprising:
detecting a malfunction by comparing the calculated delivered fluid volume against a target volume and transmitting a health metric alert via the wireless mesh network if a discrepancy is detected.

20. An irrigation system comprising:
a plurality of sprinkler heads, each acting as a node in a self-healing mesh network;
each sprinkler head comprising an internal micro-turbine generator, a processor, and a digitally controlled valve; and
a central gateway in wireless communication with at least one of the plurality of sprinkler heads; wherein
the central gateway is configured to backhaul telemetry from the plurality of sprinkler heads and transmit updated sector-specific irrigation profiles to the sprinkler heads based on external weather data.

21. The irrigation system of claim 20 wherein:
the self-healing mesh network is configured to utilize routed unicasting to transmit instructions to a specific sprinkler head, the instructions comprising at least a unique head ID, a start angle, a stop angle and a target volume.
